(19) United States
(12) Patent Application Publication
(10) Pub. No.: US 2025/0269416 A1
(43) Pub. Date: Aug. 28, 2025

(54) IN-LINE ADHESIVE PROCESS FOR LAMINATED CORES

(71) Applicant: TEMPEL STEEL COMPANY, CHICAGO, IL (US)

(72) Inventors: DAVID K. FOWLER, EWING, IL (US); MICHAEL RIVERA-VEGA, CHICAGO, IL (US); MARK BENDER, ALGONQUIN, IL (US); JOHN SIFFER, NAPERVILLE, IL (US)

(21) Appl. No.: 19/046,120

(22) Filed: Feb. 5, 2025

Related U.S. Application Data
(60) Provisional application No. 63/558,232, filed on Feb. 27, 2024.

(51) Int. Cl. B21D 22/02; B32B 7/12; B32B 15/01

(52) U.S. Cl. CPC B21D 22/02; B32B 7/12; B32B 15/01

(57) ABSTRACT

A machine assembly configured to process a roll of sheet metal to form a laminated core is provided. The assembly includes an uncoiler configured to uncoil the roll of sheet metal. An adhesive application apparatus arranged downstream of the uncoiler is configured to apply an adhesive to the sheet metal. A first curing apparatus is arranged downstream of the adhesive application apparatus and is configured to partially cure the adhesive. A stamp and punch machine is arranged downstream of the first curing apparatus and is configured to stamp and punch the sheet metal to form stamped metal pieces. A stacking apparatus is configured to form a stack of the stamped metal pieces. A second curing apparatus is configured to fully cure the adhesive between each stamped metal piece in the stack to form the laminated core.

### RELATED APPLICATIONS

This application claims the benefit of U.S. Provisional Application No. 63/558,232 filed on Feb. 27, 2024, which is hereby incorporated herein by reference.

### TECHNICAL FIELD

In general, the present invention relates to a machine assembly used to apply an adhesive to a sheet metal, and in particular to an in-line adhesive process using the machine assembly to produce a laminated core.

### BACKGROUND OF THE INVENTION

Electric motors convert electrical energy into mechanical energy to rotate a rotor around a stator. In some instances, when electrical energy is applied to the motor, magnetic forces form and cause the rotor to rotate around the stator. Instead of using a monolithic, solid metal piece, each of the rotor and stator of an electric motor may comprise a laminated core to reduce eddy current losses and thus, improve efficiency of the electric motor. A laminated core includes a stack of thin metal stamped sheets that are bonded together. The metal sheet material, bonding technique, and overall shape, among other things, of each laminated core may influence the overall cost and performance of the electric motor.

### SUMMARY OF THE INVENTION

In accordance with an embodiment of the present invention, a machine assembly is provided. The assembly includes an uncoiler configured to uncoil a roll of sheet metal and a straightener configured to receive and straighten the sheet metal after uncoiling. The assembly further includes an adhesive application apparatus arranged downstream of the straightener and configured to apply an adhesive to one side of the sheet metal. A first curing apparatus is arranged downstream of the adhesive application apparatus and is configured to partially cure the adhesive. A stamp and punch machine is arranged downstream of the first curing apparatus and is configured to stamp and punch the sheet metal to form stamped metal pieces. A stacking apparatus is configured to form a stack of the stamped metal pieces. A second curing apparatus is configured to fully cure the adhesive between each stamped metal piece in the stack to form a laminated core.

In accordance with another embodiment of the present invention, a method for forming a stack of stamped metal pieces is provided. The method includes obtaining a roll of sheet metal; loading the roll of sheet metal onto an uncoiler; uncoiling the roll of sheet metal using the uncoiler; aligning and straightening the sheet metal after uncoiling; applying adhesive to one side of the sheet metal; partially curing the adhesive in a first curing apparatus; punching and stamping the sheet metal to form stamped metal pieces coated in the adhesive; stacking the stamped metal pieces; and fully curing the adhesive to bond the stamped metal pieces to one another.

In accordance with yet another embodiment of the present invention, a laminated core is provided. The laminated core includes a first metal layer, a second metal layer, and a third metal layer. Further, a first adhesive layer is arranged between the first metal layer and the second metal layer, and a second adhesive layer is arranged between the second metal layer and the third metal layer. The laminated core is made by a process that includes the steps of: obtaining a roll of sheet metal; loading the roll of sheet metal onto an uncoiler; uncoiling the roll of sheet metal using the uncoiler; aligning and straightening the sheet metal after uncoiling; applying adhesive to one side of the sheet metal; partially curing the adhesive in a first curing apparatus; punching and stamping the sheet metal to form the first metal layer, the second metal layer, and the third metal layer, wherein the adhesive forms the first adhesive layer over the first metal layer and the second adhesive layer over the second metal layer; stacking the first metal layer, the second metal layer, and the third metal layer; and fully curing the first adhesive layer and the second adhesive layer to bond the first metal layer, the second metal layer, and the third metal layer to one another to form the laminated core.

These and other objects of this invention will be evident when viewed in light of the drawings, detailed description and appended claims.

### BRIEF DESCRIPTION OF THE DRAWINGS

FIG. 1 illustrates a schematic of some embodiments of a machine assembly configured to uncoil a roll of sheet metal, apply an adhesive to the sheet metal, partially cure the adhesive, and stamp metal pieces from the sheet metal.

FIG. 2 illustrates a block diagram of some embodiments of the machine assembly of FIG. 1.

FIG. 3 illustrates a flow diagram of some embodiments of a method of applying an adhesive to a sheet metal while the sheet metal is continuously being uncoiled.

FIG. 4A illustrates a schematic of some other embodiments of the machine assembly disclosed herein that further comprises a loop control between a first curing apparatus and a stamp and punch machine.

FIG. 4B illustrates a schematic of some other embodiments of the machine assembly disclosed herein that comprises a cooling component between a first curing apparatus and a stamp and punch machine.

FIG. 5 illustrates a perspective view of some embodiments of the adhesive application apparatus.

FIG. 6 illustrates a perspective view of some embodiments of the adhesive application apparatus and first curing apparatus.

FIGS. 7, 8, 9, and 10 illustrate various views of some embodiments of the first curing apparatus comprising induction coils.

FIGS. 11 and 12 illustrate various views of some embodiments of the first curing apparatus arranged in an angled configuration with respect to the sheet metal.

FIG. 13 illustrates some embodiments of using two of the first curing apparatuses to partially cure an adhesive on a sheet metal.

FIG. 14 illustrates some embodiments of a laminated core comprising adhesive layers arranged between stamped metal pieces.

FIG. 15 illustrates some other embodiments of a laminated core comprising adhesive layers arranged between interlocking stamped metal pieces.

FIG. 16 illustrates yet some other embodiments of a laminated core comprising adhesive layers arranged between stamped metal pieces comprising through-holes.

### DETAILED DESCRIPTION OF THE INVENTION

Embodiments of the application relate to methods and assemblies that relate to coating a sheet metal with an adhesive just after the sheet metal is uncoiled within a same assembly line. The adhesive may then be partially cured before undergoing stamping and punching to form stamped metal pieces from the adhesive-coated sheet metal. The stamped metal pieces may be stacked and undergo a final curing process to form a laminated core comprising several stamped metal pieces bonded to one another with the adhesive. To uncoil the sheet metal, a roll of the sheet metal is loaded onto an uncoiler. Prior to being loaded onto the uncoiler, the roll of sheet metal does not comprise any adhesive. Over time, an adhesive that is not fully cured may breakdown. Thus, without any adhesive, the roll of sheet metal has a much longer shelf-life, thereby reducing waste. With a longer shelf-life, a laminated core producer can purchase a bulk amount of adhesive-less rolls of sheet metal and/or may have a large inventory of different types of materials for the sheet metal. Thus, the laminated core producer can customize which adhesive and metal materials to use upon producing the laminated core, thereby increasing the amount of design options available to a customer of laminated cores.

With reference to the drawings, like reference numerals designate identical or corresponding parts throughout the several views. However, the inclusion of like elements in different views does not mean a given embodiment necessarily includes such elements or that all embodiments of the invention include such elements. The examples and figures are illustrative only and not meant to limit the application, which is measured by the scope and spirit of the claims.

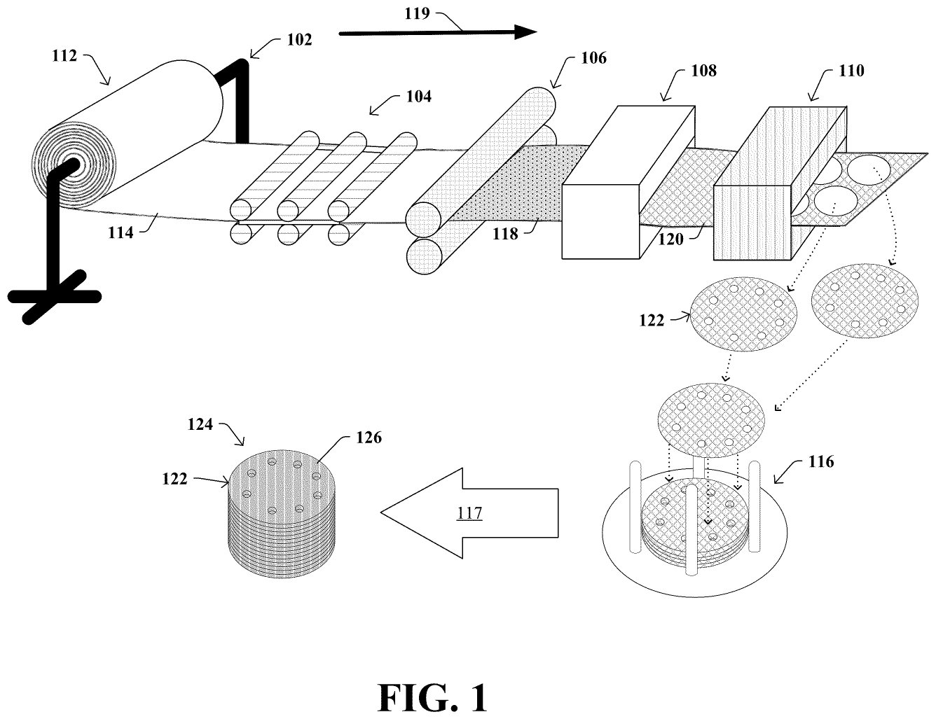

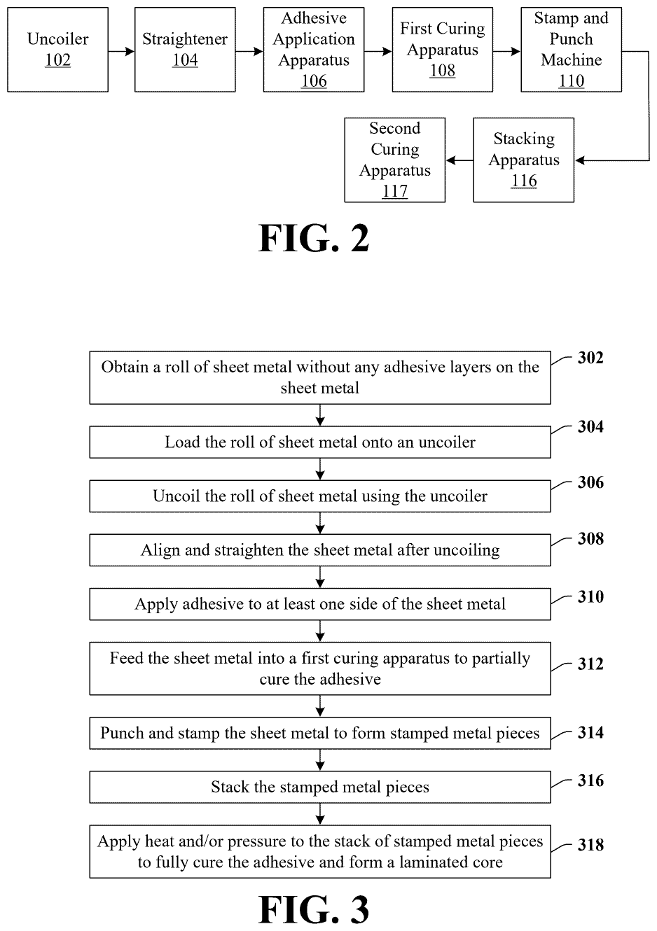

Turning now to FIGS. 1 and 2, an exemplary assembly line of machinery for processing a roll 112 of sheet metal 114 is illustrated. FIG. 1 illustrates a schematic of the machinery, and FIG. 2 illustrates a block diagram that corresponds to the machinery in FIG. 1.

The exemplary assembly line includes an uncoiler 102, a straightener 104 arranged downstream of the uncoiler 102, an adhesive application apparatus 106 arranged downstream of the straightener 104, a first curing apparatus 108 arranged downstream of the adhesive application apparatus 106, and a stamp and punch machine 110 arranged downstream of the first curing apparatus 108. The uncoiler 102 is configured to receive a roll 112 of sheet metal 114 and to uncoil the roll 112 of sheet metal 114 such that the sheet metal 114 can be fed into each component of the exemplary assembly line for processing. The sheet metal 114 is uncoiled and fed into the components generally in a feed direction 119. The assembly line may include one or more feeds configured to continuously guide the sheet metal 114 between the uncoiler 102 and the stamp and punch machine 110 at a predetermined speed. In some embodiments, the predetermined speed is in a range of between, for example, about 10 meters per minute and about 75 meters per minute. The one or more feeds may be conveyer belts, one-sided rollers, two-sided rollers, or some other suitable structure configured to push and/or pull the sheet metal 114 between components of the assembly line.

In some embodiments, the sheet metal 114 may comprise steel or some other metal available in a sheet form and suitable for laminated cores. The roll 112 of sheet metal 114 does not include any adhesive on the sheet metal 114 when loaded onto the uncoiler 102. Without adhesive on the roll 112 of sheet metal 114, the shelf-life of the roll 112 can be extended and more customized adhesives may be applied to the sheet metal 114 in-line between uncoiling and stamping. In other words, prior to loading the roll 112 onto the uncoiler 102, the roll 112 may be stored in a warehouse for an extended period of time. For example, the roll 112 may be stored in the warehouse for over six months. The roll 112 may also be stored in the same warehouse where the uncoiler 102 and other components of the assembly line are located. Additionally, because the sheet metal 114 is not precoated with an adhesive prior to being loaded onto the uncoiler 102, the roll 112 of sheet metal 114 may be purchased from a variety of metals manufacturers. In some embodiments, the roll 112 of sheet metal 114 may include an insulating layer on one or both sides of the sheet metal 114 prior to loading the roll 112 onto the uncoiler 102. Non-limiting examples of an insulating layer include C5 or C5A class coatings.

The adhesive application apparatus 106 is configured to apply an adhesive 118 to one or both sides of the sheet metal 114. In some embodiments, the adhesive 118 is applied to only one side of the sheet metal 114 for simplicity and cost-savings. Additionally, the adhesive 118 may fully cover or substantially cover the one or both sides of the sheet metal 114. After coating the sheet metal 114 with adhesive 118, the sheet metal 114 is fed into the first curing apparatus 108 to dry and/or partially cure the adhesive 118. The first curing apparatus 108 may comprise a variety of curing system methods such as hot box, induction, heat tunnel, and infra-red systems. In some embodiments, the adhesive 118 may be cured to what is commonly known as a “B-stage” cure, which is a partial cure (i.e., partial cross-linking) of the adhesive 118. In some other embodiments, the adhesive 118 may be heated to remove the water from the adhesive 118, but not enough to start any cross-linking of the adhesive 118. By only removing the water from the adhesive 118 without curing the adhesive coating, a thinner adhesive 118 can be applied to the sheet metal 114 to save materials cost and less heat and time are used at this stage to reduce energy usage and manufacturing costs. Examples of the adhesive 118 include adhesives that can be controlled to cure to a B-stage and then to a C-stage and that are configured to adhere adjacent metals to one another upon C-stage curing but may also provide electrical insulation between such metals. Other examples of the adhesive 118 include an adhesive that cures when in contact with an activator or that cures when exposed to pressure.

After the dry and/or partial cure of the adhesive 118, the sheet metal 114 with a partially cured adhesive coating 120 is fed into a stamp and punch machine 110 to form stamped metal pieces 122 comprising the partially cured adhesive coating 120 arranged over the sheet metal 114. The stamp and punch machine 110 and any other associated feeds or machine components downstream of the first curing apparatus 108 remain substantially clean from adhesive residue because the adhesive coating 120 is partially cured. After going through the stamp and punch machine 110, multiple stamped metal pieces 122 are aligned and stacked with one another using a stacking apparatus 116. The stacked, stamped metal pieces 122 may then enter a second curing apparatus 117. Under various temperature, time, and pressure conditions in the second curing apparatus 117, the partially cured adhesive coating 120 on each stamped metal piece 122 can fully cure (sometimes known as “C-stage” curing) and bond to a surface of an adjacent stamped metal piece 122 to produce a reliable laminated core 124. The laminated core 124 comprises fully cured adhesive layers 126 arranged between the stamped metal pieces 122.

Turning additionally to FIG. 3, an exemplary flow chart of a method of using the assembly line of machinery to form a laminated core is shown. The method of FIG. 3 may correspond to various steps illustrated in FIGS. 1 and 2. It will be appreciated that other steps may be incorporated into the flow chart of FIG. 3 such as cleaning steps, cutting steps, aligning steps, and cooling steps, among other things.

At step 302, a roll of sheet metal is obtained without any adhesive layers already on the sheet metal. At step 304, the roll of sheet metal is loaded onto an uncoiler. At step 306, the roll of sheet metal is uncoiled by the uncoiler. At step 308, the sheet metal is aligned and straightened after uncoiling. At step 310, an adhesive is applied to at least one side of the sheet metal. At step 312, the sheet metal is fed into a first curing apparatus to partially cure the adhesive. At step 314, the sheet metal is punched and stamped to form stamped metal pieces. At step 316, the stamped metal pieces are stacked with one another. At step 318, heat and/or pressure is applied to the stack of stamped metal pieces to fully cure the adhesive and form a laminated core.

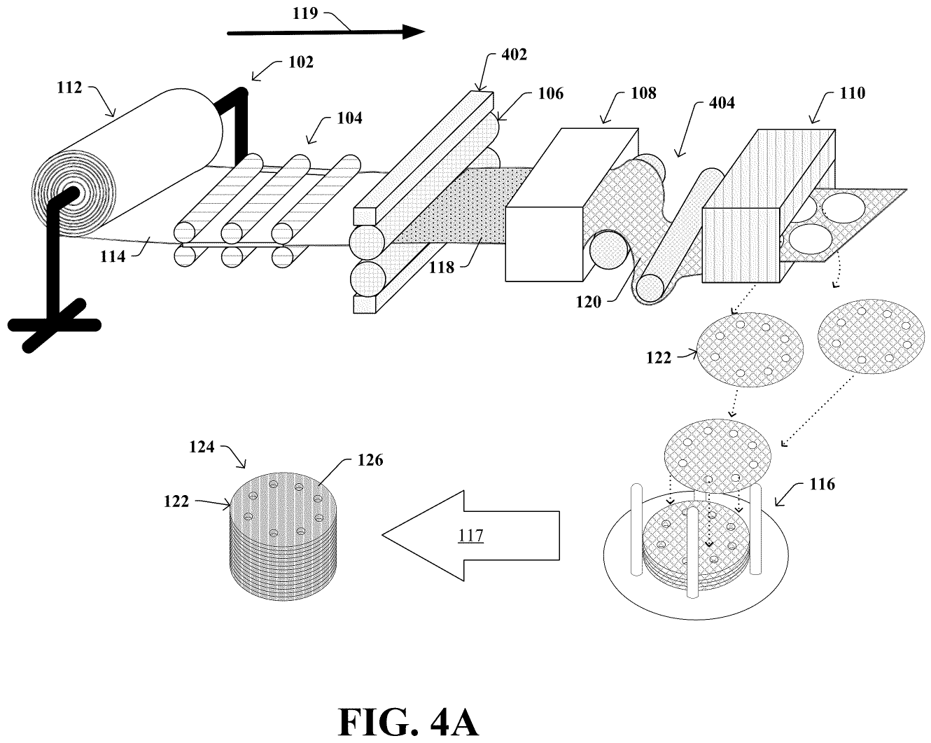

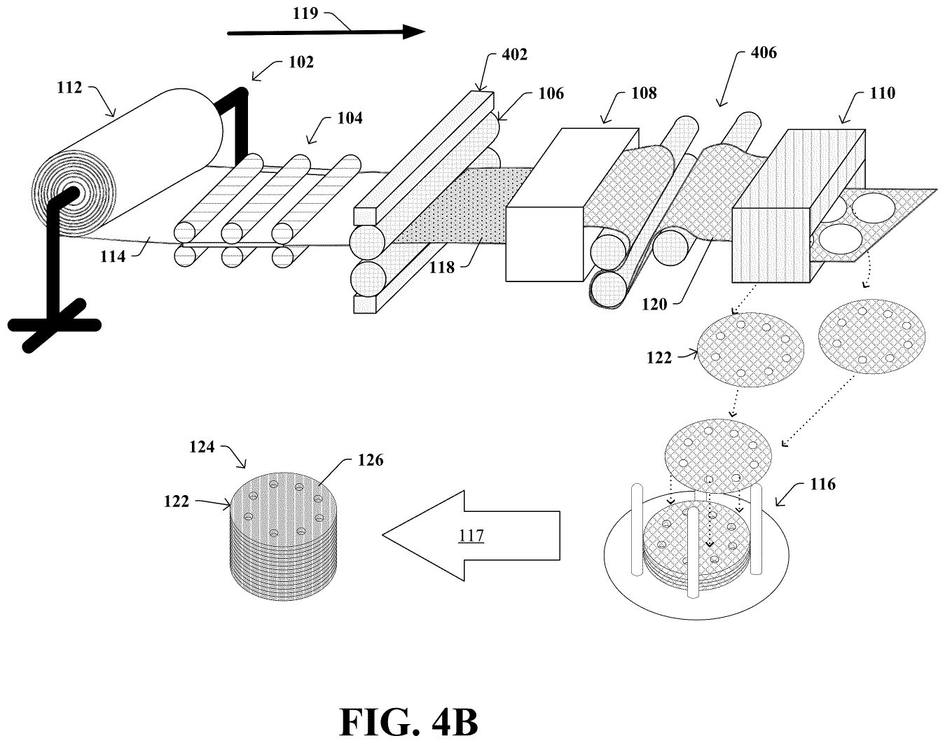

Turning additionally to FIG. 4A, the exemplary assembly line of FIG. 1 is illustrated but with additional components. In some embodiments, several more components are utilized in the exemplary assembly line. Additionally, it will be appreciated that FIGS. 1, 4A, and 4B simply illustrate schematics of the various components in the assembly line and that various details such as electrical and mechanical connections to each component are omitted for simplicity.

In some embodiments, a cleaning system 402 is coupled to or integrated with the adhesive application apparatus 106. The cleaning system 402 is configured to flush the adhesive application apparatus 106 of the old adhesive 118 if the adhesive application apparatus 106 is clogged or of a different adhesive is desired. Other cleaning systems may also be used throughout the exemplary assembly line. For example, in some embodiments, a cleaning system may be arranged between the uncoiler 102 and the adhesive application apparatus 106 to clean any contaminants from the sheet metal 114 prior to applying the adhesive 118.

In some embodiments, a loop control 404 is arranged between the first curing apparatus 108 and the stamp and punch machine 110. The loop control 404 is configured to hold the sheet metal 114 that is coming out of the first curing apparatus 108 at a predetermined speed because the stamp and punch machine 110 may not be able receive a continuous feed of the sheet metal 114 at the same predetermined speed. The loop control 404 may be an S-loop, a U-loop, or some other suitable embodiment.

In some embodiments, the assembly line may comprise a slitting machine configured to cut the sheet metal 114 after uncoiling to a desired width. Thus, in some embodiments, the slitting machine may be arranged before the uncoiler and/or the adhesive application apparatus 106. Several other components that are conventional to sheet metal processing may also be implemented throughout the exemplary assembly line by one of ordinary skill in the art to address other needs.

Turning additionally to FIG. 4B, in some embodiments, the assembly line comprises a cooling component 406 arranged downstream of the first curing apparatus 108 to cool the sheet metal 114 after partial curing. In some embodiments, the cooling component 406 is arranged between the first curing apparatus 108 and the stamp and punch machine 110. While a partial cure at the first curing apparatus 108 can reduce sticking of the adhesive at the stamp and punch machine 110, the sheet metal 114 may exit the first partial curing apparatus 108 at an undesirably high temperature for stamp and punching processing at the stamp and punch machine 110, resulting in nonuniform stamped metal pieces 122. Therefore, the cooling component 406 can reduce the temperature of the sheet metal 114 immediately after the first curing apparatus 108 and before entering the stamp and punch machine 110.

As shown in FIG. 4B, the cooling component 406 comprises a series of cooling rollers that at least contact the sheet metal 114 opposite the surface at which the partially cured adhesive coating 120 is arranged. In some embodiments, the partially cured adhesive coating 120 contacts at least one of the rollers. For example, in FIG. 4B, the first and third cooling rollers contact the sheet metal 114 opposite the surface at which the partially cured adhesive coating 120 is arranged, while the second cooling roller contacts the partially cured adhesive coating 120. When the cooling component 406 is a series of cooling rollers, the cooling component 406 could also provide loop control. In other embodiments, it will be appreciated that the cooling component 406 may be a fan, a cold box, or some other suitable cooling machine configured to reduce the temperature of the sheet metal 114 as desired. It will be appreciated that a loop control (e.g., 404 of FIG. 4A) may be used in addition to the cooling component 110.

The need for a cooling component 110, the type of cooling component 110, and/or the amount of cooling provided by the cooling component 110 can depend on, for example, the type of adhesive, the thickness of the adhesive, the width of the sheet metal 114, the thickness of the sheet metal 114, the stamp and punch design, the operating parameters of the stamp and punch machine 110, the distance between the first curing apparatus 108 and the stamp and punch machine 110, the parameters of the final full cure process at the second curing apparatus 117, and/or the partial curing temperature used at the first curing apparatus 108, among other factors. For example, in some applications, a higher partial cure temperature at the first curing apparatus 108 aids in eliminating adhesive squeeze-out during the final curing process at the second curing apparatus 117, whereas in some other embodiments, a lower partial cure temperature at the first curing apparatus 108 aids in sealing properties of the finally cured laminated core at the second curing apparatus 117. The presence of the cooling component 110 and the ability to tune the parameters of the cooling component 110 for a desired application can improve the overall final cured laminated core.

As an example, in some embodiments, the first curing apparatus 108 operates at a temperature that is almost 200 degrees Celsius greater than the desired sheet metal temperature for the proceeding stamp and punch machine 110. In some such embodiments, the cooling component 110 is configured to cool the temperature of the sheet metal 114 and partially cured adhesive coating 120 by around 200 degrees Celsius in the short time/distance between the first curing apparatus 108 and the stamp and punch machine 110. For example, in some embodiments, the partial curing at the first curing apparatus 108 may occur at a temperature between around 200 degrees Celsius and around 250 degrees Celsius, while the stamp and punch machine 110 should operate at a temperature below about 50 degrees Celsius to provide reliable stamped metal pieces 122. In some such embodiments, the series of cold rollers 110 may sufficiently cool the sheet metal 114 by 200 degrees Celsius before entering the stamp and punch machine 110. In other embodiments, if a lower temperature is used at the first curing apparatus 108 and subsequent cooling is not necessary or is not as extreme, the cooling component 110 may be turned OFF.

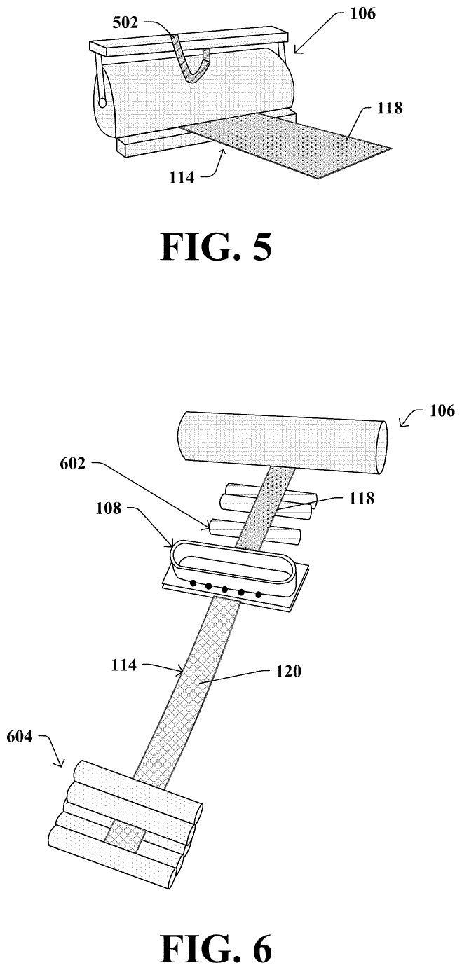

Turning additionally to FIG. 5, a magnified view of an exemplary adhesive application apparatus 106 is shown. In some embodiments, the adhesive application apparatus 106 is a roll coater and includes tubing 502 to dispense the adhesive 118 through the rollers and onto an entire surface area of at least one side of the sheet metal 114. The entire surface of the at least one side of the sheet metal 114 may be coated in the adhesive 118 such that the laminated core 124 at the end of production has strong, even adhesive layers 126 between each stamped metal piece 122. In some other embodiments, the adhesive 118 may not be applied near the edges of the sheet metal 114. In some such embodiments, the uncoated edges of the sheet metal 114 may be scraped during the punching and stamping steps such that the stamped metal pieces 122 are fully coated on at least one side with the partially cured adhesive coating 120. The adhesive application apparatus 106 may apply the adhesive 118 to the sheet metal 114 at a desired thickness. The thickness of the adhesive 118 may be controlled by the pressure of application between the rollers, the temperature of the adhesive 118, sheet metal 114, and/or roller, and/or the viscosity of the adhesive 118, for example. In some other embodiments, the adhesive application apparatus 106 may be a spray coater, a curtain coater, or some other suitable coating apparatus that distributes the adhesive 118 over the sheet metal 114.

In some other embodiments, a two-part adhesive may be applied to the sheet metal 114. In some such embodiments, the adhesive application apparatus 106 may be configured to apply a first adhesive-type to one side of the sheet metal 114 and a second adhesive-type to the other side of the sheet metal 114. In some such embodiments, both the first and second adhesive-types may be partially cured in the first curing apparatus 108. Upon stacking the stamped metal pieces 122 at the stacking apparatus 112, the stamped metal pieces 122 may be stacked such that the first adhesive-type from one stamped metal piece 122 contacts the second adhesive-type from an adjacent stamped metal piece 122. In some embodiments, one of the first or second adhesive-types is a curing activator configured to cure the other adhesive-type. Upon contact, pressure, and/or heat, the first and second adhesive-types may fully cure to bond each stamped metal piece 122 to one another to form the laminated core 124. In some other embodiments, a same adhesive-type may be applied to both sides of the sheet metal 114 by the adhesive application apparatus 106. In the aforementioned embodiments where one or more adhesives are applied to both sides of the sheet metal 114, the first curing apparatus 108 is configured to partially cure the adhesive on both sides of the sheet metal 114.

Turning additionally to FIG. 6, a perspective view of an exemplary adhesive application apparatus 106, first curing apparatus 108, a first feed 602, and a second feed 604 are shown. In some embodiments, several feeds 602, 604 are located throughout the assembly line to ensure that the sheet metal 114 is traveling through the assembly line at a desired speed. The feeds 602, 604 may comprise one-sided roller systems, such as the first feed 602 in FIG. 6; may comprise two-sided roller systems, such as the second feed 604 in FIG. 6; may comprise a conveyer belt system; or may comprise some other system that feeds the sheet metal 114 through the assembly line at a desired speed. Various controls and motors may be coupled to the feeds 602, 604 to control the desired speed of the sheet metal 114.

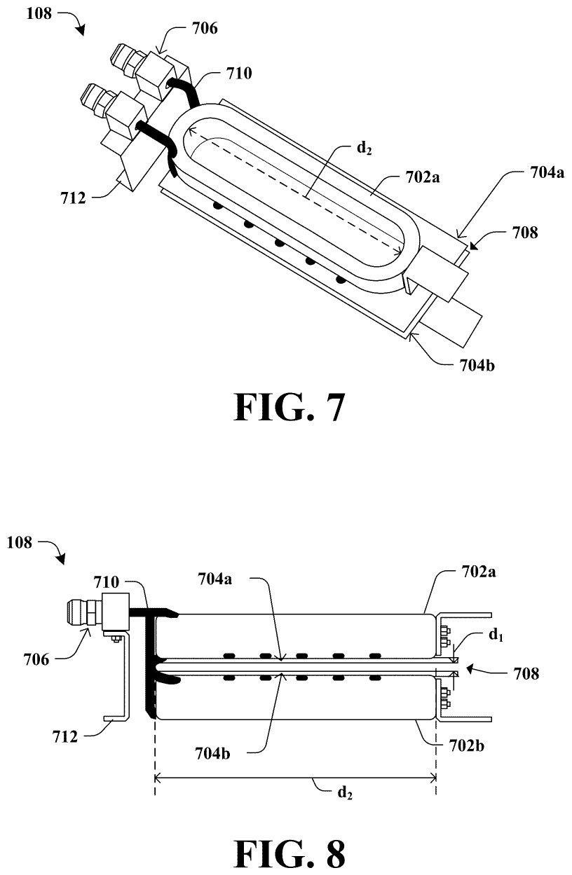

Turning additionally to FIGS. 7 and 8, the first curing apparatus 108 may include an induction coil heater. In some such embodiments, the induction coil heater includes a first coil housing 702a arranged on a first plate 704a and a second coil housing 702b arranged on a second plate 704b. The first and second plates 704a, 704b may be arranged between the first and second coil housings 702a, 702b. The first plate 704a is spaced apart from the second plate 704b by a gap 708, the height of the gap 708 equal to a first distance d₁. A length between opposite inner surfaces of the first housing coil 702a (and second housing coil 702b) defines a second distance d₂, which is a width direction of sheet metal 114 passing through the first curing apparatus and coaxial with axis 1204 (FIG. 12). The first distance d₁ may be measured along a direction perpendicular to the feed direction 119 (a length direction of sheet metal 114 passing through the first curing apparatus), in some embodiments.

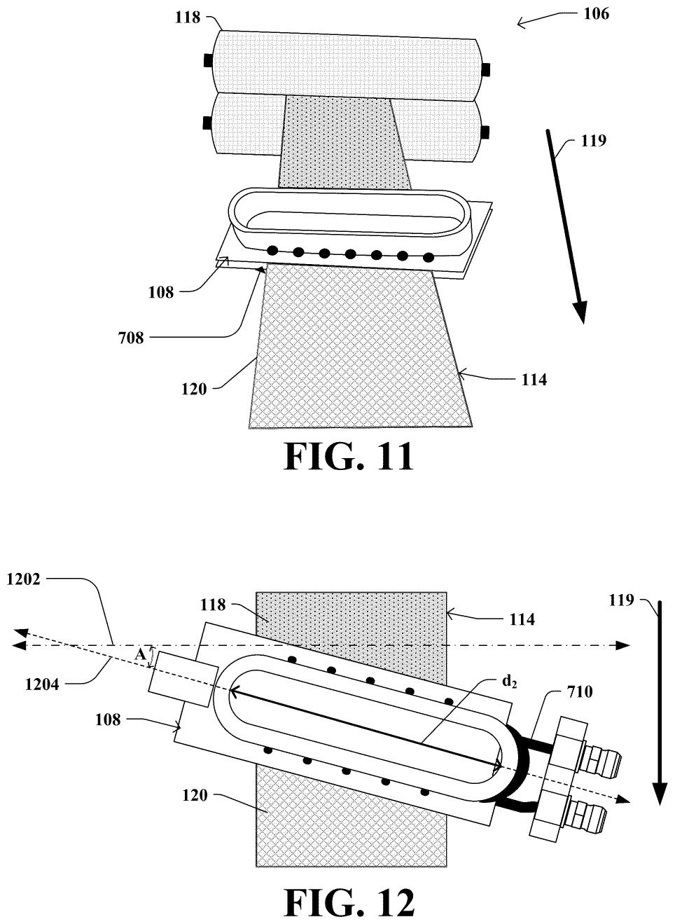

The gap 708 is dimensioned to be big enough to accommodate the sheet metal 114 as the sheet metal 114 travels through the gap 708 of the first curing apparatus 108. Thus, the first distance d₁ is greater than a thickness of the sheet metal 114 traveling through the assembly line. As shown in FIG. 11, the second distance d₂ is greater than a width of the sheet metal 114 traveling through the assembly line. In some other embodiments, the second distance d₂ may be less than a width of the sheet metal 114 if, for example, more than one first curing apparatus 108 is used (e.g., FIG. 13). Each of the first coil housing 702a and the second coil housing 702b house a coil 710 that is arranged within the coil housings 702a, 702b and coupled to terminals 706 to receive power from a power source. The coil 710 is arranged such that the adhesive 118 on the sheet metal 114 can be partially cured via induction heating as the sheet metal 114 travels through the gap 708. The material, size, and configuration of the coil 710 and the power source may be adjusted to provide suitable induction heating for the adhesive 118 based on the size of the sheet metal 114, the speed at which the sheet metal 114 travels, and the like. The first curing apparatus 108 may be coupled to the assembly line via various support structures 712. To avoid shorting the first curing apparatus 108 and/or damaging the adhesive 118 and sheet metal 114, the gap 708 is dimensioned such that the adhesive 118 and/or the sheet metal 114 can travel through the gap 708 of the first curing apparatus 108 without contacting the first or second plates 704a, 704b of the first curing apparatus 108. In some embodiments, the first plate 704a, the second plate 704b, the first coil housing 702a, and/or the second coil housing 702b comprise an electrically insulating material such as a plastic to mitigate the change of shorting the first curing apparatus 108 if the sheet metal 114 unintentionally contacted the first curing apparatus 108.

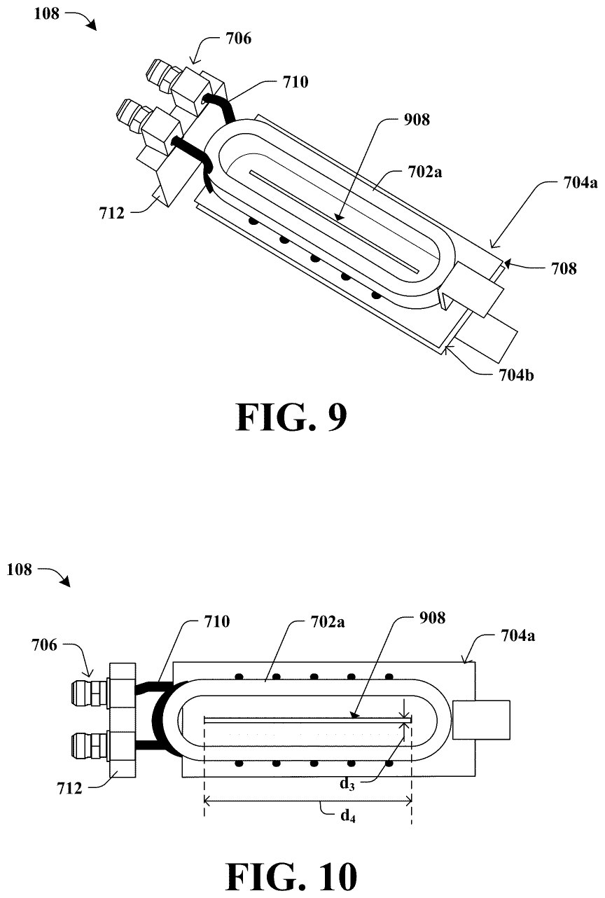

Turning additionally to FIGS. 9 and 10, in some embodiments, when the first curing apparatus 108 is an induction coil heater, the first and second plates 704a, 704b may each include a passthrough portion 908 that extends entirely through each of the first and second plates 704a, 704b. The passthrough portion 908 may be dimensioned such that the sheet metal 114 can travel through the passthrough portion 908 to partially cure the adhesive 118 on the sheet metal 114 via induction heating. In this implementation, the first curing apparatus is oriented perpendicular to the orientation of the first curing apparatus in FIGS. 7 and 8. The first coil housing 702a may surround the passthrough portion 908 in the first plate 704a, and the second coil housing 702b may surround the passthrough portion 908 in the second plate 704b. Each of the passthrough portions 908 in the first and second plates 704a, 704b may have a height equal to a third distance d₃ and a width equal to a fourth distance d₄. The third distance d₃ is greater than the thickness of the sheet metal 114, and the fourth distance d₄ is greater than the width of the sheet metal 114 such that the adhesive 118 and/or the sheet metal 114 can travel through the passthrough portions 908 of the first curing apparatus 108 without contacting the first or second plates 704a, 704b of the first curing apparatus 108. Otherwise, the first curing apparatus 108 could short out and stop working and/or the adhesive 118 and sheet metal 114 could be damaged. In some other embodiments, the second coil housing 702b and the second plate 704b may be omitted from the first curing apparatus 108.

Turning additionally to FIGS. 11 and 12, in some embodiments, the first curing apparatus 108 is angled with respect to the feed direction 119 of the sheet metal 114. FIG. 11 illustrates a perspective view of the sheet metal 114 traveling from the adhesive application apparatus 106 and through the first curing apparatus 108. FIG. 12 illustrates a top view of the first curing apparatus 108, corresponding to the first curing apparatus 108 of FIG. 11.

As best shown in FIG. 12, the sheet metal 114 travels through the first curing apparatus 108 in the feed direction 119, which is coincident with a length of the sheet metal 114. The sheet metal 114 has a width measured in a second direction 1202 perpendicular to the feed direction 119. The second distance d₂ of the first curing apparatus 108 defines a maximum heating path that the first curing apparatus 108 can provide. The second distance d₂ extends along a third direction 1204 that intersects with the second direction 1202 at an angle A such that the first curing apparatus 108 can partially cure a length of the sheet metal 114 that is larger than the width of the sheet metal 114, which may increase the curing efficiency of the first curing apparatus 108. The angle A is less than ninety degrees and equal to a value that ensures the entire area of the adhesive 118 is partially cured as it travels through the first curing apparatus 108.

FIGS. 11 and 12 illustrate the first curing apparatus 108 as an induction coil heater, where the sheet metal 114 travels through the gap 708 of the first curing apparatus 108 between the first and second plates 704a and 704b. It will be appreciated that this angled orientation of the first curing apparatus 108 may also apply to embodiments where the first curing apparatus 108 is a hot box (gas-fired or electric), an infrared heater, a UV light, a moisture chamber, forced air devices, a steam heater, a radiant heater, or some other suitable curing device. Additionally, it will be appreciated that this angled orientation of the first curing apparatus 108 may also apply to embodiments where the first curing apparatus 108 is an induction coil heater having a passthrough portion 908 as shown in FIGS. 9 and 10 such that the sheet metal 114 travels through that passthrough portion 908 for partial curing of the adhesive 118. As shown in FIG. 12, when the first curing apparatus 108 is in an angled orientation, the angle A is a non-zero angle. In some other embodiments, as shown in FIG. 6, for example, the angle A is equal to zero because the maximum heating path is equal to the width of the sheet metal 114.

Turning additionally to FIG. 13, in some other embodiments, the maximum heating path of a first curing apparatus 108a or 108b is less than the width of the sheet metal 114. In some such embodiments, two first curing apparatuses 108a, 108b may be used and partially overlap along the feed direction 119 to ensure all surfaces of the adhesive 118 partially cures to form the partially cured adhesive coating 120 after passing through the first curing apparatuses 108a, 108b.

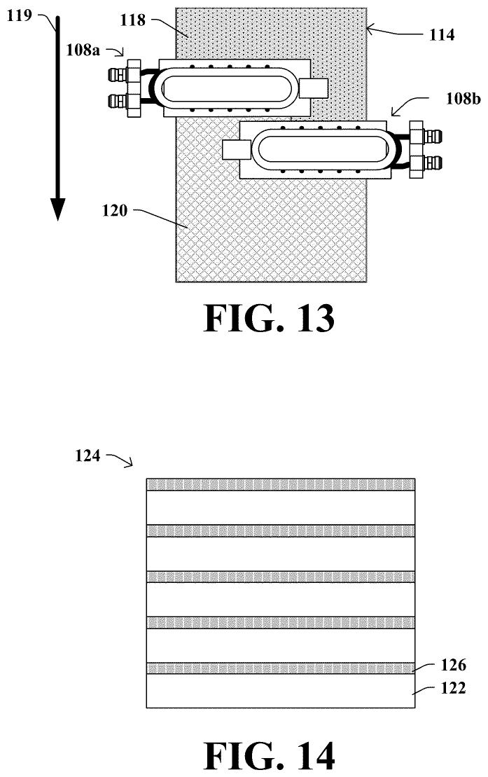

Turning additionally to FIG. 14, a sideview or cross-sectional view of some embodiments of the laminated core 124 is illustrated. The laminated core 124 comprises a stack of alternating layers of the stamped metal pieces 122 and the fully cured adhesive layer 126. The fully cured adhesive layers 126 may be arranged on a top surface of each stamped metal piece 122 and contact a bottom surface of each metal piece 122. In some other embodiments, fully cured adhesive layers 126 may be arranged on both sides of each metal piece 122 such that adjacent fully cured adhesive layers 126 contact one another when forming the laminated core 124.

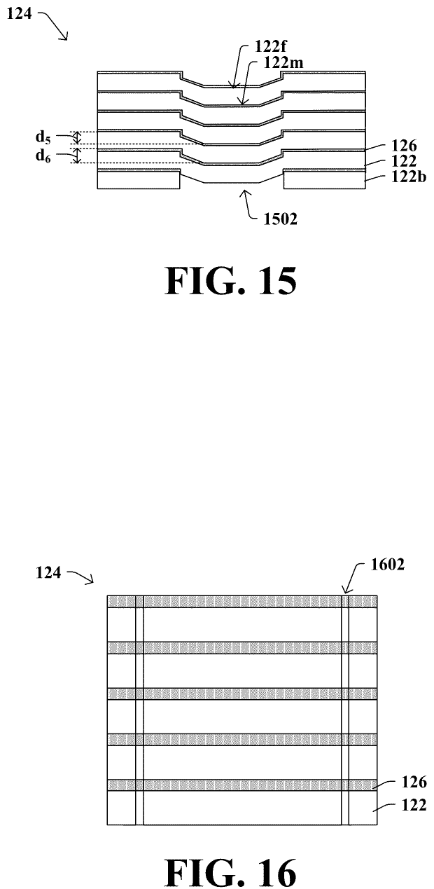

Turning additionally to FIG. 15, a cross-sectional view of some embodiments where the laminated core 124 comprises interlocked stamped metal pieces 122 is illustrated. In some such embodiments, each stamped metal piece 122 of the laminated core 124 may comprise an interlocking region comprising a female portion 122f and a male portion 122m. The female and male portions 122f, 122m are formed at the stamp and punch machine 110. For example, the stamped metal piece 122 may be punched from the sheet metal 114 and the male portion 122m of the stamped metal piece 122 is pushed into a corresponding female portion 112f of a preceding stamped metal piece 112. When the desired number of stamped metal pieces 122 are stacked, additional punches may be made to form the laminated core 124. The female portion 122f is configured to receive and interlock with a male portion 122m of an adjacent stamped metal piece 122. The fully cured adhesive 126 may be arranged between each stamped metal piece 122, even at the female and male portions 122f, 122m to further secure each stamped metal piece 122 to one another to form the laminated core.

In some embodiments, the female portion 122f is on a topside of each stamped metal piece 122, and the male portion 122m is on a bottomside of each stamped metal piece 122. It will be appreciated that in some other embodiments, the female portion 122f is on a bottomside of each stamped metal piece 122, and the male portion 122m is on a topside of each stamped metal piece 122. The female portion 122f may comprises an indentation with a depth extending from a top surface of the stamped metal piece 122 by a fifth distance d₅. The male feature 122m may protrude outwards from a bottom surface of the stamped metal piece 122 by a sixth distance d₆. In some embodiments, the fifth distance d₅ is less than the sixth distance d₆. For example, a difference between the sixth distance d₆ and the fifth distance d₅ may be between about 0.0002 inches and about 0.0004 inches. In some embodiments, a bottommost stamped metal piece 122b comprises an opening 1502 configured to receive the male portion 122m of an overlying stamped metal piece 122. The bottommost stamped metal piece 122b may comprise the opening 1502 that extends partially or fully through the bottommost stamped metal piece 122b such that a bottommost surface of the laminated core 124 is substantially flat.

Turning additionally to FIG. 16, in some embodiments, one or more through-holes 1602 are formed in each stamped metal piece 122 at the stamp and punch machine 110. Each through-hole 1602 may extend through the thickness of the fully cured adhesive 126 and the stamped metal piece 122. The through-holes 1602 may be aligned as each stamped metal piece 122 is stacked to form the laminated core 124. It will be appreciated that a laminated core 124 may comprise the through-holes 1602 as illustrated in FIG. 16 as well as interlocking male and female portions 122m, 122f as illustrated in FIG. 15.

The aforementioned systems, components (e.g., uncoiler, adhesive apparatus, first curing apparatus, among others), and the like have been described with respect to interaction between several components and/or elements. It should be appreciated that such devices and elements can include those elements or sub-elements specified therein, some of the specified elements or sub-elements, and/or additional elements. Further yet, one or more elements and/or sub-elements may be combined into a single component to provide aggregate functionality. The elements may also interact with one or more other elements not specifically described herein.

While the embodiments discussed herein have been related to the apparatus, systems and methods discussed above, these embodiments are intended to be exemplary and are not intended to limit the applicability of these embodiments to only those discussions set forth herein.

The above examples are merely illustrative of several possible embodiments of various aspects of the present invention, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (e.g., that is functionally equivalent), even though not structurally equivalent to the disclosed structure which performs the function in the illustrated implementations of the invention. In addition although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

The best mode for carrying out the invention has been described for purposes of illustrating the best mode known to the applicant at the time and enable one of ordinary skill in the art to practice the invention, including making and using devices or systems and performing incorporated methods. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof. The patentable scope of the invention is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

What is claimed is:

1. A machine assembly for producing a laminated core comprising:
an uncoiler configured to uncoil a roll of sheet metal;
an adhesive application apparatus arranged downstream of the uncoiler and configured to apply an adhesive to at least one side of the sheet metal;
a first curing apparatus arranged downstream of the adhesive application apparatus and configured to partially cure the adhesive;
a stamp and punch machine arranged downstream of the first curing apparatus and configured to stamp and punch the sheet metal to form stamped metal pieces;
a stacking apparatus configured to form a stack of the stamped metal pieces; and
a second curing apparatus configured to fully cure the adhesive between each stamped metal piece in the stack to form the laminated core.

2. The machine assembly of claim 1, further comprising one or more feeds arranged between the uncoiler and the stamp and punch machine such that the sheet metal can continuously travel through the uncoiler, the adhesive application apparatus, and the first curing apparatus.

3. The machine assembly of claim 1, further comprising a straightener arranged between the uncoiler and the adhesive application apparatus, wherein the straightener is configured to receive and straighten the sheet metal after uncoiling.

4. The machine assembly of claim 1, further comprising a loop control arranged between the first curing apparatus and the stamp and punch machine.

5. The machine assembly of claim 1, wherein the first curing apparatus is an induction coil heater.

6. The machine assembly of claim 5, wherein the induction coil heater is arranged at a non-zero angle with respect to the width of the sheet metal such that a heating length is greater than a width of the sheet metal.

7. The machine assembly of claim 1, wherein the adhesive application apparatus is a roll coater and is configured to only coat one side of the sheet metal with the adhesive.

8. The machine assembly of claim 1, further comprising a cleaning system arranged between the uncoiler and the adhesive application apparatus.

9. The machine assembly of claim 1, further comprising a cleaning system coupled to the adhesive application apparatus and configured to flush out adhesive from the adhesive application apparatus.

10. A method of producing a laminated core, the method comprising:
obtaining a roll of sheet metal;
loading a roll of sheet metal onto an uncoiler;
uncoiling the roll of sheet metal using the uncoiler;
aligning and straightening the sheet metal after uncoiling;
applying adhesive to at least one side of the sheet metal;
partially curing the adhesive in a first curing apparatus;
punching and stamping the sheet metal to form stamped metal pieces coated in the adhesive;
stacking the stamped metal pieces; and
fully curing the adhesive to bond the stamped metal pieces to one another to form the laminated core.

11. The method of claim 10, wherein the adhesive is applied to the sheet metal downstream from the uncoiler, and wherein the first curing apparatus is arranged downstream from the uncoiler.

12. The method of claim 10, wherein the first curing apparatus is an induction coil heater.

13. The method of claim 10, further comprising cutting the sheet metal after uncoiling and before applying adhesive to one side of the sheet metal.

14. The method of claim 10, wherein the roll of sheet metal is free of adhesive before being loaded onto the uncoiler.

15. The method of claim 10, wherein the adhesive is applied to only one side of the sheet metal.

16. The method of claim 10, wherein the adhesive is applied to the sheet metal using a roll coater.

17. The method of claim 10, further comprising storing the roll of sheet metal within a warehouse, wherein the roll of sheet metal is obtained from the warehouse, and wherein the uncoiler is arranged within the warehouse.

18. The method of claim 17, wherein the roll of sheet metal is stored in the warehouse for over six months prior to obtaining the roll of sheet metal from the warehouse.

19. A laminated core comprising:
a first metal layer;
a second metal layer;
a third metal layer;
a first adhesive layer arranged between the first metal layer and the second metal layer; and
a second adhesive layer arranged between the second metal layer and the third metal layer, wherein the laminated core is made by a process comprising the steps of:
obtaining a roll of sheet metal;
loading the roll of sheet metal onto an uncoiler;
uncoiling the roll of sheet metal using the uncoiler;
aligning and straightening the sheet metal after uncoiling;
applying adhesive to at least one side of the sheet metal;
partially curing the adhesive in a first curing apparatus;
punching and stamping the sheet metal to form the first metal layer, the second metal layer, and the third metal layer, and wherein the adhesive forms the first adhesive layer over the first metal layer and the second adhesive layer over the second metal layer;
stacking the first metal layer, the second metal layer, and the third metal layer; and
fully curing the first adhesive layer and the second adhesive layer to bond the first metal layer, the second metal layer, and the third metal layer to one another to form the laminated core.

20. The laminated core of claim 19, wherein the roll of sheet metal is obtained from a storage area within a warehouse, and wherein the steps of the process to form the laminated core occur in the warehouse.
